(19) United States
(12) Patent Application Publication
(10) Pub. No.: US 2017/0054121 A1
(43) Pub. Date: Feb. 23, 2017

(54) BATTERY PACK

(71) Applicant: Robert Bosch GmbH, Stuttgart (DE)

(72) Inventors: Sarmimala Hore, Stuttgart (DE); Andreas Letsch, Stuttgart (DE); Andreas Jesse, Freudental (DE); Dominik Koch, Stuttgart (DE); Joerg Poehler, Korntal-Muenchingen (DE)

(21) Appl. No.: 15/242,829

(22) Filed: Aug. 22, 2016

(30) Foreign Application Priority Data
Aug. 21, 2015 (DE) 10 2015 216 014.9

(51) Int. Cl. H01M 2/12; H01M 10/615; H01M 10/052; H01M 10/657; H01M 10/63; H01M 2/10; H01M 10/625

(52) U.S. Cl. CPC H01M 2/1223; H01M 2/1094; H01M 2/1077; H01M 10/615; H01M 10/625; H01M 10/657; H01M 10/63; H01M 10/052; H01M 2220/20

(57) ABSTRACT

A battery pack (50) comprising at least one battery cell (2) and an enclosure (52) for thermal insulation of the at least one battery cell (2). In this case, the enclosure (52) has at least one closable ventilation opening (60).

### BACKGROUND OF THE INVENTION

The invention relates to a battery pack which comprises at least one battery cell and an enclosure for thermal insulation of the battery cell.

Electrical energy is storable by means of batteries. Batteries convert chemical reaction energy into electrical energy. A distinction is made here between primary batteries and secondary batteries. Primary batteries are functional only once, whereas secondary batteries, which are also known as storage batteries, are rechargeable. A battery comprises one or more battery cells in this case.

Secondary batteries are used inter alia in vehicles, in particular in electric vehicles (EV), hybrid electric vehicles (HEV) and in plug-in hybrid electric vehicles (PHEV).

Battery cells have a positive electrode, which is also known as a cathode, and a negative electrode, which is also known as an anode. During a discharging process of the battery cell, electrons flow from the anode to the cathode in an outer electrical circuit. Within the battery cell, lithium ions flow from the anode to the cathode during a discharging process.

The cathode and the anode each comprise a current collector to which an active material is applied. The current collectors of the two electrodes are electrically connected to poles of the battery cell, which are also known are terminals, by means of collectors.

Battery cells furthermore have a cell housing which is produced for example from aluminum and is thus electrically conductive. The cell housing is generally configured in a prismatic, in particular cuboidal, manner and designed to be pressure-resistant. The terminals are in this case located outside said cell housing.

Battery cells known from the prior art are optimally operable only in a limited working temperature range. Temperatures that are too high can trigger irreversible chemical reactions, and this can result in a capacity loss or even destruction of the battery cell. At temperatures that are too low, the mobility of the lithium ions can be reduced, with the result that the performance of the battery cell is reduced.

A battery having an enclosure for thermal insulation is known for example from US 2007/0264485 A1. The enclosure in that case contains in particular a fiber-reinforced aerogel material.

An enclosure for thermal insulation, which contains aerogel material, is also known from US 2007/0238008 A1. The enclosure in that case serves inter alia for thermal insulation of a battery, in particular in a vehicle.

DE 10 2012 214 957 A1 discloses a heat management system for vehicles, which comprises in particular a vacuum insulation panel.

DE 10 2022 057 108 A1 discloses heat insulation in vehicles, in particular in vehicle heating appliances. In that case, panels made of aerogel are provided, inter alia.

### SUMMARY OF THE INVENTION

A battery pack is proposed, which comprises at least one battery cell and an enclosure for thermal insulation of the at least one battery cell. The enclosure for thermal insulation is intended in this case to have comparatively low thermal conductivity, for example in the region of 14 mWm⁻¹ K⁻¹.

According to the invention, the enclosure of the battery pack has at least one closable and also reopenable ventilation opening. With the ventilation opening closed, the battery cells inside the enclosure are thermally insulated from the surroundings and heat exchange between the battery cells and the surroundings is reduced. With the ventilation opening opened, heat exchange between the battery cells and the surroundings is allowed. In particular, it is possible for heat to be released to the surroundings.

Preferably, the enclosure of the battery pack contains an aerogel. Aerogel has a particularly high thermal insulation capacity and a comparatively low specific weight. Aerogel is obtainable for example as “polymer-crosslinked aerogel material” or as “fiber-reinforced aerogel blanket”.

Advantageously, the ventilation opening in the enclosure of the battery pack is closable and also reopenable by means of an electrically actuable closure means. This allows either a release of heat to the environment, in particular in order to cool battery cells to their optimal working temperature, or thermal insulation of the battery cells.

The closure means can be configured for example in the form of a pivotable flap or of a displaceable curtain. The closure means can also be in the form of a door or sliding door. Other configurations are also conceivable. The closure means can be formed in one or more parts, for example in the form of a sectional door having a plurality of sections connected together.

Preferably, the closure means contains an aerogel. As already mentioned, aerogel has a particularly high thermal insulation capacity and a comparatively low specific weight.

According to an advantageous configuration of the invention, a control unit which is connected to at least one temperature sensor is provided for actuating the closure means. Thus, if the temperature is too high, the ventilation opening can be opened by actuation of the closure means by the control unit, in order to allow heat to be released and in order to cool the battery cells to their optimal working temperature. At a sufficiently low temperature, the ventilation opening can be closed by actuation of the closure means by the control unit, in order to reduce to prevent the temperature of the battery cells from dropping further.

According to an advantageous development of the invention, an electrical heating device is provided inside the enclosure. As a result, it is possible for the battery cells to be heated to their optimal working temperature inside the enclosure.

According to an advantageous configuration of the invention, a control unit which is connected to at least one temperature sensor is provided for actuating the electrical heating device. Thus, if the temperature is too low the heating device can be switched on in order to heat the battery cells to their optimal working temperature. At a sufficiently high temperature, the heating device can be switched off in order to prevent the battery cells from heating up further.

Preferably, the at least one battery cell has a solid electrolyte. As a result, freezing of an electrolyte that is liquid at ambient temperature is avoided.

Particularly preferably, the at least one battery cell is a lithium-sulfur battery cell. Such a battery cell has for example a cathode which contains a sulfur-carbon compound, and a lithium anode. A lithium-sulfur battery cell has an increased storage capacity compared with a conventional lithium-ion battery cell.

A battery pack according to the invention is advantageously used in an electric vehicle (EV), in a hybrid electric vehicle (HEV) or in a plug-in hybrid electric vehicle (PHEV).

As a result of the configuration according to the invention of the battery pack, an active cooling system for cooling the battery cells, in particular a cooling system with liquid cooling, is not necessary. Thus, the production costs and the weight of the battery pack drop.

Aerogel as a means for thermal insulation is a tried and tested material in practice with very low thermal conductivity. An enclosure made of aerogel with a thickness of less than 10 mm is already highly suitable for thermal insulation. Aerogel, in particular at this thickness, is textile-like and thus flexible. Therefore, aerogel is easily shapeable; in particular, it can be cut, sewn and laminated. Therefore, the production of an enclosure which surrounds the battery cells in a flush manner, is able to be carried out in a comparatively simple manner. Furthermore, aerogel is pressure-resistant, non-crushable, incompressible and has high mechanical strength. Aerogel is also water-repellent and temperature-stable to above 500° C.

In particular currently known lithium-sulfur battery cells have a comparatively high optimal working temperature of for example 80° C. As a result of the configuration according to the invention of the battery pack, it is comparatively easily possible to operate the battery cells of the battery pack at said working temperature. In particular, operation of the battery cells of the battery pack in a comparatively narrow temperature range around the working temperature, avoiding large temperature fluctuations, is possible. As a result, the lifetime of the battery cells increases.

After first, initial heating of the battery cells of the battery pack to the optimal working temperature of the battery cells of for example 80° C. and electrical charging, the battery pack is ready for operation. As a result of the configuration according to the invention, said optimal working temperature of the battery cells is always maintained under almost all conceivable climatic conditions, in particular regardless of the ambient temperature, and other conditions.

### BRIEF DESCRIPTION OF THE DRAWINGS

Embodiments of the invention are described in more detail by way of the drawings and the following description.

In the drawings:

FIG. 1 shows a schematic illustration of a battery pack,

FIG. 2 shows a schematic, perspective illustration of a battery pack with closed ventilation opening, and

FIG. 3 shows a schematic, perspective illustration of a battery pack with opened ventilation opening.

### DETAILED DESCRIPTION

In the following description of the embodiments of the invention, identical or similar elements are denoted by the same reference signs, wherein a repeated description of these elements is dispensed with in individual cases. The figures illustrate the subject matter of the invention only schematically.

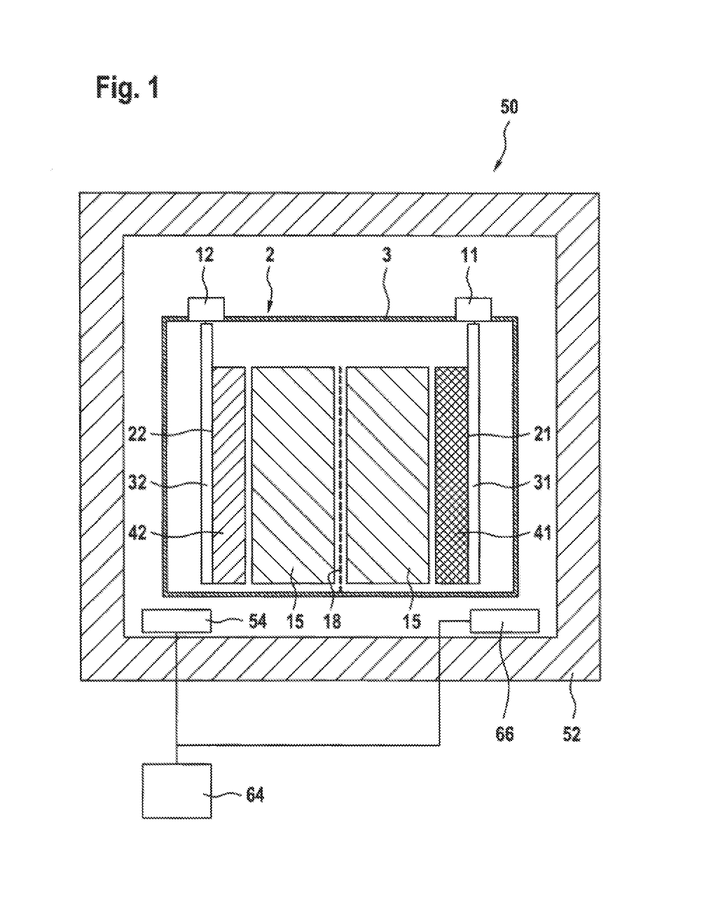

FIG. 1 schematically illustrates a battery pack 50. The battery pack 50 comprises a plurality of battery cells 2, wherein only one battery cell 2 is shown in the present illustration. The battery pack 50 is fastened for example to a vehicle (not illustrated) and serves in particular as a traction battery for driving the vehicle.

The battery cell 2 comprises a cell housing 3 which is formed in a prismatic, in the present case cuboidal, manner. The cell housing 3 is configured in an electrically conductive manner in the present case and produced for example from aluminum. The cell housing 3 can also be produced from an electrically insulating material, for example plastics material, however.

The cell housing 3 of the battery cell 2 is surrounded by an enclosure 52. The enclosure 52 of the battery pack 50 serves for thermal insulation of the battery cell 2. The enclosure 52 of the battery pack 50 is made of aerogel.

The battery cell 2 comprises a negative terminal 11 and a positive terminal 12. Via the terminals 11, 12, a voltage provided by the battery cell 2 can be tapped off. Furthermore, the battery cell 2 can also be charged via the terminals 11, 12. The terminals 11, 12 are arranged in a spaced-apart manner on a covering surface of the prismatic cell housing 3.

Arranged within the cell housing 3 of the battery cell 2 is an electrode winding which has two electrodes, namely an anode 21 and a cathode 22. The anode 21 and the cathode 22 are each embodied in a foil-like manner and wound to form the electrode winding with a separator 18 being interposed. It is also conceivable for a plurality of electrode windings to be provided in the cell housing 3. Instead of the electrode winding, it is also possible for example for an electrode stack to be provided.

The anode 21 comprises an anodic active material 41 which is embodied in a foil-like manner. The anode 21 furthermore comprises a current collector 31 which is likewise formed in a foil-like manner. The anodic active material 41 and the current collector 31 of the anode 21 are placed flat against one another and connected together. The current collector 31 of the anode 21 is embodied in an electrically conductive manner and produced from a metal, for example copper. The current collector 31 of the anode 21 is electrically connected to the negative terminal 11 of the battery cell 2 by means of a collector.

The cathode 22 comprises a cathodic active material 42 which is embodied in a foil-like manner. The cathode 22 furthermore comprises a current collector 32 which is likewise formed in a foil-like manner. The cathodic active material 42 and the current collector 32 of the cathode 22 are placed flat against one another and connected together. The current collector 32 of the cathode 22 is embodied in an electrically conductive manner and produced from a metal, for example aluminum. The current collector 32 of the cathode 22 is electrically connected to the positive terminal 12 of the battery cell 2 by means of a collector.

The anode 21 and the cathode 22 are separated from one another by a separator 18. The separator 18 is likewise formed in a foil-like manner. The separator 18 is formed in an electrically insulating manner, but is ionically conductive, i.e. permeable to lithium ions.

The battery cell 2 is in the present case a lithium-sulfur battery cell. The battery cell 2 in this case contains a solid electrolyte 15 which surrounds the anode 21, the cathode 22 and the separator 18 inside the cell housing 3 of the battery cell 2. The solid electrolyte 15 is also ionically conductive and serves to transport lithium ions between the anode 21 and the cathode 22.

Also provided inside the enclosure 52 of the battery pack 50 is an electrical heating device 54. By means of the heating device 54, it is possible to heat the battery cells 2 inside the enclosure 52. The energy required by the electrical heating device 54 to heat the battery cells 2 is provided in this case by the battery cells 2 themselves.

The battery pack 50 comprises a control unit 64 which serves to actuate the electrical heating device 54. The control unit 64 is connected to a temperature sensor 66 for sensing the temperature of the battery cells 2. The temperature sensor 66 is arranged inside the enclosure 52. When the control unit 64 emits a corresponding signal to the electrical heating device 54, the heating device 54 is switched on or switched off.

The control unit 64 is arranged outside the enclosure 52 of the battery pack 50 in the present case. However, an arrangement of the control unit 64 inside the enclosure 52 of the battery pack 50 is also conceivable.

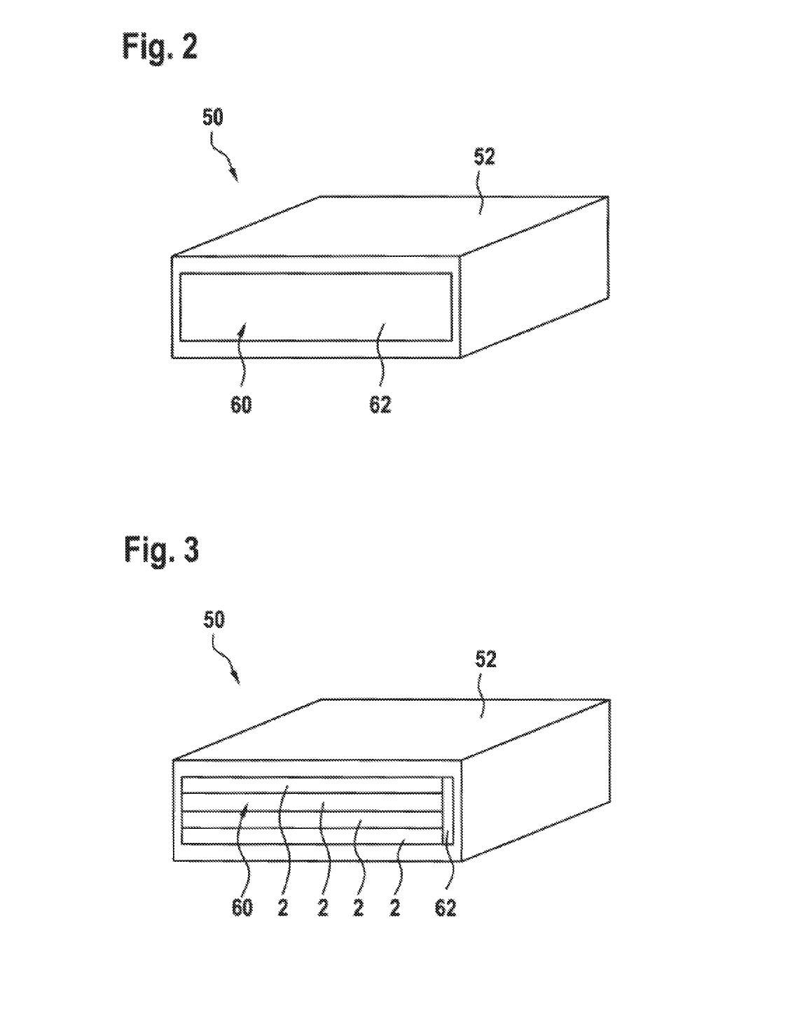

FIG. 2 shows a schematic, perspective illustration of a battery pack 50. The battery pack 50 is configured in an approximately cuboidal manner in the present case. Other designs, for example cylindrical, are also conceivable. The battery cells 2, which are concealed in the illustration shown, are surrounded virtually completely by the enclosure 52.

The enclosure 52 of the battery pack 50 has a closable ventilation opening 60. A plurality of ventilation openings 60 can also be provided. In the illustration shown, the ventilation opening 60 is closed by means of an electrically actuable closure means 62. The closure means 62 of the battery pack 50 is also produced from aerogel in the present case. It is also conceivable to produce the closure means 62 from other materials, for example from a polymer.

The closure means 62 is configured in the form of a displaceable curtain in the present case. Other configurations of the closure means 62 are also conceivable, for example in the form of a pivotable flap. A design of the closure means 62 in the form of a door or sliding door is also conceivable. The closure means 62 can in this case be formed in one or more parts. For example, the closure means 62 can be in the form of a sectional door with a plurality of sections that are connected together.

In order to drive the closure means 62 to open and close the ventilation opening 60, an actuator (not illustrated here) is provided. The actuator is for example an electric motor. The energy required by the actuator to drive the closure means 62 to open and close the ventilation opening 60 is in this case provided by the battery cells 2 themselves.

The control unit 64 (not illustrated in FIG. 2), which serves to actuate the electrical heating device 54, also serves to actuate the closure means 62. When the control unit 64 emits a corresponding signal to the actuator to actuate the closure means 62, the ventilation opening 60 is opened or closed.

FIG. 3 shows a schematic, perspective illustration of the battery pack 50 with opened ventilation opening 60. The closure means 62 has been pushed to the side by the actuator and thus clears the ventilation opening 60 virtually completely. Visible through the opened ventilation opening 60 are a plurality of battery cells 2, which are arranged inside the enclosure 52.

The battery pack 50, which is configured in an approximately cuboidal manner in the present case, is held in a frame (not illustrated) which is produced for example from a metal or a polymer. If the frame is made of metal, it has an electrically insulating protective layer or coating.

It is also conceivable to hold the battery cells 2 directly in the frame and to surround the frame with the enclosure 52. In this case, the battery cells 2 and the frame are located inside the enclosure 52. The frame can in this case act as an electrical heating device 54 and serve to heat the battery cells 2.

The heating device 54 can comprise a plurality of, in particular two, heating segments. The two heating segments are preferably arranged inside the enclosure 52 such that the battery cells 2 are located in between. In particular, one heating segment is located above the battery cells 2 and one heating segment is located beneath the battery cells 2.

If the temperature inside the battery pack 50 rises above a predeterminable threshold value, the temperature sensor 66 emits a corresponding signal to the control unit 64. Thereupon, the control unit 64 emits a signal to the actuator to actuate the closure means 62, in the present case to open the ventilation opening 60. When the ventilation opening 60 has been opened, the battery cells 2 are cooled by the airstream while the vehicle is on the move.

If the temperature inside the battery pack 50 rises above the predeterminable threshold value when the vehicle is at a standstill, for example while the battery cells 2 are being charged, no airstream for cooling is available. In this case, an additional fan, for example a ventilator, can be provided to generate a suitable airflow for cooling battery cells 2. Likewise, an additional cooling system with liquid cooling can be provided.

If the temperature inside the battery pack 50 drops below the predeterminable threshold value again, the temperature sensor 66 emits a corresponding signal to the control unit 64. Thereupon, the control unit 64 emits a signal to the actuator to actuate the closure means 62, in the present case to close the ventilation opening 60. When the ventilation opening 60 has been closed by the closure means 62, the battery cells 2 are thermally insulated again inside the enclosure 52.

If the temperature inside the battery pack 50 drops below a predeterminable threshold value, the temperature sensor 66 emits a corresponding signal to the control unit 64. Thereupon, the control unit 64 switches the electrical heating device 54 on. When the temperature inside the battery pack 50 rises above a predeterminable threshold value again, the temperature sensor 66 emits a corresponding signal to the control unit 64. Thereupon, the control unit 64 switches the electrical heating device 54 off again.

If the temperature inside the battery pack 50 drops heavily while the vehicle is at a standstill for a prolonged time, for example during winter, the energy present in the battery cells 2 may not be enough to heat the battery cells 2 by means of the electrical heating device 54. In this case, heating of the battery cells 2 by means of an external heat source is first of all necessary.

The invention is not limited to the exemplary embodiments described here and the aspects highlighted therein. Rather, a large number of modifications which are within the scope of practice of a person skilled in the art are possible within the scope specified by the claims.

1. A battery pack (50) comprising
at least one battery cell (2), and
an enclosure (52) for thermal insulation of the at least one battery cell (2),
wherein the enclosure (52) has at least one closable ventilation opening (60).

2. The battery pack (50) according to claim 1, characterized in that the enclosure (52) contains an aerogel.

3. The battery pack (50) according to claim 1, further comprising an electrically actuable closure means (62) for closing the ventilation opening (60).

4. The battery pack (50) according to claim 3, characterized in that the closure means (62) contains an aerogel.

5. The battery pack (50) according to claim 3, further comprising a control unit (64) which is connected to at least one temperature sensor (66) and which is configured for actuating the closure means (62).

6. The battery pack (50) according to claim 1, further comprising an electrical heating device (54) inside the enclosure (52).

7. The battery pack (50) according to claim 6, further comprising a control unit (64) which is connected to at least one temperature sensor (66) and which is configured for actuating the electrical heating device (54).

8. The battery pack (50) according to claim 1, characterized in that the at least one battery cell (2) has a solid electrolyte (15).

9. The battery pack (50) according to claim 1, characterized in that the at least one battery cell (2) is a lithium-sulfur cell.

10. The battery pack (50) according to claim 2, further comprising an electrically actuable closure means (62) for closing the ventilation opening (60).

11. The battery pack (50) according to claim 10, characterized in that the closure means (62) contains an aerogel.

12. The battery pack (50) according to claim 11, further comprising a control unit (64) which is connected to at least one temperature sensor (66) and which is configured for actuating the closure means (62).

13. The battery pack (50) according to claim 12, further comprising an electrical heating device (54) inside the enclosure (52).

14. The battery pack (50) according to claim 13, further comprising a control unit (64) which is connected to at least one temperature sensor (66) and which is configured for actuating the electrical heating device (54).

15. The battery pack (50) according to claim 14, characterized in that the at least one battery cell (2) has a solid electrolyte (15).

16. The battery pack (50) according to claim 15, characterized in that the at least one battery cell (2) is a lithium-sulfur cell.
